(19) United States
(12) Patent Application Publication
(10) Pub. No.: US 2024/0285046 A1
(43) Pub. Date: Aug. 29, 2024

(54) HUNTING STICK

(71) Applicant: Joseph John Luciano, Altoona, PA (US)

(72) Inventor: Joseph John Luciano, Altoona, PA (US)

(21) Appl. No.: 18/585,265

(22) Filed: Feb. 23, 2024

Related U.S. Application Data
(60) Provisional application No. 63/447,744, filed on Feb. 23, 2023.

(51) Int. Cl. A45B 5/00; A01M 31/02; A45B 9/00; A45B 9/04; F41A 23/16

(52) U.S. Cl. CPC A45B 5/00; A01M 31/025; A45B 9/04; F41A 23/16; A45B 2009/007; A45B 2200/05

(57) ABSTRACT

The present invention is directed to a hunting stick that incorporates elements of and functions as a walking stick, a gun rest, and/or a hunting blind.

### CROSS-REFERENCE TO RELATED APPLICATION

This application claims priority to U.S. Provisional Application Ser. No. 63/447,744, filed Feb. 23, 2023, which application is incorporated by reference herein in its entirety.

### BACKGROUND OF THE INVENTION

### Field of the Invention

The present invention is a device that serves multiple functions as a walking stick and a hunting accessory.

### Description of Related Art

The present invention is directed to a hunting stick device that serves as a walking stick, a shooting rest, and/or a hunting blind in different combinations. The hunting stick is broadly fashioned to look and perform like a standard walking stick. However, the hunting stick of the present invention has an easy-to-deploy gun rest near the top of the hunting stick. Additionally, some embodiments of the hunting stick of the present invention include an easy-to-deploy hunting blind.

Walking sticks, hiking sticks, and trekking poles (collectively referred to as “walking stick(s)” herein) are long, sturdy poles used when walking or hiking. The use of one or two walking sticks creates three or four points of contact between the user and the ground (the first two points of contact being the user's feet). These extra points of contact increase balance and stability especially on uneven terrain, steep ascents or descents, wet or muddy trails, loose rocks and other difficult to traverse terrain. Frequently, hunters are walking and hunting on uneven or difficult to traverse terrain where walking sticks would be helpful. However, hunters carry a lot of other hunting gear that can make the addition of walking sticks not feasible.

Another technology frequently used by hunters are shooting sticks, shooting rests, hunting rests, or gun rests (“rests”). A rest can have many different designs including being designed to be similar to a walking stick or as a tripod. Essentially, a hunting rest provides support and stability for a hunter's weapon. Ideally, a rest should be very quick and easy to set-up so that if a hunter sees an animal, he or she can deploy the rest, position his/her weapon, and take aim at the animal.

Finally, another technology used by hunters is a hunting blind. A hunting blind is a camouflage or concealment device or shelter for hunters designed to reduce the chance of detection by animals. Ideally the hunting blind is designed for fast deployment so that a hunter can set up his/her blind quickly and take aim at the animal without being detected. Examples of walking sticks, shooting rests, and hunting blinds exist in the field. However, while there are many publications disclosing various aspects of the present invention, none of these publications contain all of the elements of the present invention designed as an easy-to-carry and fast-to-deploy single device.

### BRIEF SUMMARY OF THE INVENTION

The present invention is directed to a variety of embodiments of hunting sticks. Various embodiments of a hunting stick of the present invention incorporate the general structure of a walking stick, having a top end and a bottom end, and a hunting blind secured to the walking stick structure between the top and bottom ends. An alternative embodiment of the present invention also incorporates a gun rest attached at or near the top end of the walking stick. The phrase “gun rest” is used herein to describe a structure upon which to rest a weapon or hunting device, such as a gun or archery equipment.

Various embodiments of the present invention hunting stick can incorporate at least one, optionally movable, stability foot attached near the bottom end of the walking stick to provide additional stability and support when the hunting stick is deployed as a gun rest and/or a hunting blind. Various embodiments of the present invention can be configured so that the walking stick has an adjustable length and/or so that the gun rest is moveable along the length of the walking stick.

Various embodiments of the present invention can be configured so that the gun rest transitions from a stored configuration to a deployed configuration and/or the hunting blind transitions between open and closed configurations.

Various embodiments of the present invention incorporate a hunting blind having a fan-like design that opens to provide semi-circular concealment and closes close to the walking stick. Also, some embodiments include a hunting blind that is removable from the hunting stick. The hunting blind can attach to the walking stick at one or more than one locations. Some embodiments of the present invention include a sleeve that slides over the closed hunting blind. Finally, various embodiments of the present invention incorporate a foot peg located near the bottom end of the walking stick to facilitate inserting the bottom end into a ground.

### BRIEF DESCRIPTION OF THE SEVERAL VIEWS OF THE DRAWINGS

For the purpose of facilitating understanding of the invention, the accompanying drawings and description illustrate embodiments thereof, from which the invention, various embodiments of its structures, construction and method of operation, and many advantages, may be understood and appreciated. The accompanying drawings are hereby incorporated by reference.

FIG. 1 shows one embodiment of a hunting stick of the present invention with one embodiment of an open hunting blind and one embodiment of a deployed rest;

FIGS. 2A and 2B are a side view of one embodiment of a hunting stick and a one embodiment of a hunting blind detached from one another; and

FIG. 3 shows the lower portion of one embodiment of a hunting stick with a deployed stability foot.

### DETAILED DESCRIPTION OF THE INVENTION

The following describes example embodiments in which the present invention may be practiced. This invention, however, may be embodied in many different ways, and the descriptions provided herein should not be construed as limiting in any way. Among other things, the following invention may be embodied as methods, systems, or devices. The following detailed descriptions should not be taken in a limiting sense. The accompanying drawings are hereby incorporated by reference.

Before the example embodiments of the devices and methods according to the present disclosure are disclosed and described below, it is to be understood that embodiments are not limited to those described within this disclosure. Numerous modifications and variations therein will be apparent to those skilled in the art and remain within the scope of the disclosure. It also is to be understood that the terminology used herein is for the purpose of describing specific embodiments only and is not intended to be limiting. Some embodiments of the disclosed technology will be described more fully hereinafter with reference to the accompanying drawings. This disclosed technology, however, may be embodied in many different forms and should not be construed as limited to the embodiments set forth therein.

In the following description, numerous specific details are set forth. However, it is to be understood that embodiments of the disclosed technology may be practiced without these specific details. In other instances, well-known methods, structures, and techniques have not been shown in detail in order not to obscure an understanding of this description. References to “one embodiment,” “an embodiment,” “example embodiment,” “some embodiments,” “certain embodiments,” “various embodiments,” etc., indicate that the embodiment(s) of the disclosed technology so described may include a particular feature, structure, or characteristic, but not every embodiment necessarily includes that particular feature, structure, or characteristic. Further, repeated use of the phrase “in one embodiment” does not necessarily refer to the same embodiment, although it may.

Unless otherwise noted, the terms used herein are to be understood according to conventional usage by those of ordinary skill in the relevant art. In addition to any definitions of terms provided below, it is to be understood that as used in the specification and in the claims, the terms “a” or “an” are used, as is common in patent documents, to include one or more than one. In this document, the term “or” is used to refer to a nonexclusive “or” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

While the disclosure has been described in detail and referring to specific embodiments thereof, it will be apparent to one skilled in the art that various changes and modifications can be made without departing from the spirit and scope of the embodiments. Thus, it is intended that the present disclosure covers the modifications and variations of this disclosure provided they come within the scope of the appended claims and their equivalents.

For the description, the terms “upper”, “lower”, “right”, “left”, “vertical”, “horizontal”, “top”, “bottom”, “lateral”, “longitudinal”, and derivatives thereof shall relate to the invention as it is oriented in the figures. However, it is to be understood that the invention may assume alternative variations and step sequences, unless specified to the contrary. It also is to be understood that the specific devices and processes illustrated in the attached drawings and described in this specification are simply exemplary embodiments of the invention. Hence, specific dimensions and other physical characteristics related to the embodiments disclosed are not to be limiting.

The materials described hereinafter as making up the various elements of the embodiments of the present disclosure are intended to be illustrative and not restrictive. Many suitable materials that would perform the same or a similar function as the materials described herein are intended to be embraced within the scope of the example embodiments. Such other materials not described herein can include, but are not limited to, materials that are developed after the time of the development of the invention, for example.

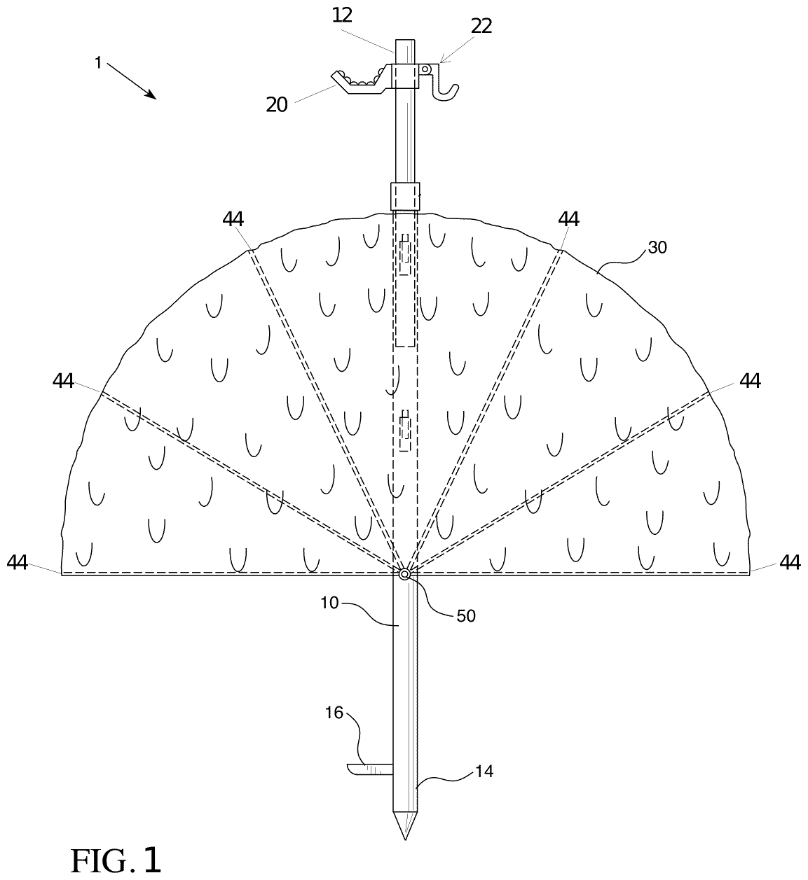

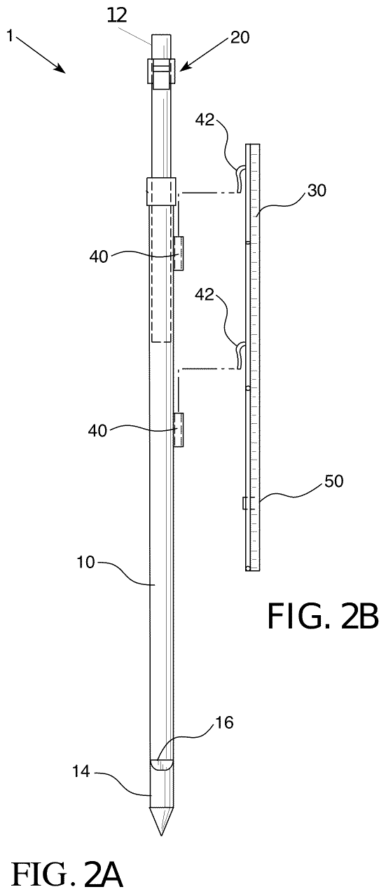

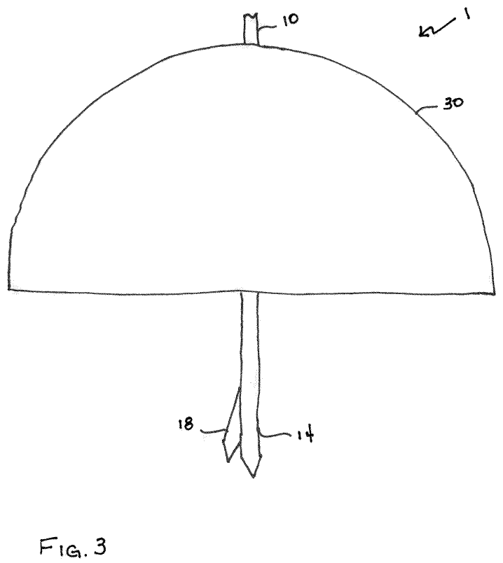

The invention comprises various combinations of elements of a walking stick 10, a shooting rest or gun rest 20, and a hunting blind 30 in one device, referred to herein as a “hunting stick 1”, as illustrated in FIGS. 1 through 3. One embodiment of a hunting stick 1 incorporates design elements of a single walking stick 10 having a top end 12 and a bottom end 14 (shown in FIGS. 1 and 2A). In some embodiments of a hunting stick 1 of the present invention, there is an optionally movable gun rest 20 at or near the top end 12 of the walking stick 10 (see FIGS. 1 and 2A). The bottom end 14 of the walking stick 10 can have any design that is known in the field of walking sticks. Some embodiments of the present invention can include a moveable or non-moveable foot peg 16 (see FIGS. 1 and 2A) located near the bottom end 14 of the walking stick 10. For embodiments configured to have the bottom end 14 inserted into the ground, a foot peg 16 provides a place for the user to step down on to aid in inserting the bottom end 14 into the ground. Some embodiments of the present invention have a bottom end 16 that has more than one prong or point to it or, alternatively as shown in FIG. 3, at least one stability foot 18 can be attached to the bottom end 14 to provide additional stability to the hunting stick 1 when in use. A stability foot/feet 18 function similar to a tripod by providing multiple points of contact between the hunting stick 1 and the ground. Additionally, various embodiments of the present invention can incorporate a walking stick 10 with a pointed bottom end 14, a blunt bottom end 14, a multi-foot configuration, and/or a pronged configuration.

Additionally in various embodiments of the present invention, there can be an attached, incorporated, and/or optionally removable hunting blind 30 that can be deployed to provide camouflage or cover to the user (as shown in FIGS. 1 and 2B). The hunting blind 30 can be configured to be permanently or removably attached to the walking stick 10. FIGS. 1, 2A, and 2b illustrate one configuration wherein the hunting blind 30 has two attachment devices 42 that correspond to two attachment points 40 on the walking stick 10. It will be obvious to one skilled in the art that there are numerous technological and mechanical arrangements that will enable the hunting blind 30 to be securely yet removably attached to the walking stick 10. In alternative embodiments of the present invention, the hunting blind 30 can be permanently attached to the walking stick 10 using any mechanical and technological arrangements known in the art. In one embodiment of the present invention, the hunting blind 30 will transition from a closed configuration (that is easy to transport, see FIGS. 2A and 2B) to an open configuration (see FIG. 1) to provide concealment to the hunter.

The walking stick portion 10 of the present invention can be made from any material that will support the weight put upon it by a user employing the hunting stick 1 as a walking stick 10 or as a gun rest 20 so that it can bear the weight and pressure put upon it without bowing excessively or breaking. Some nonlimiting example materials include aluminum, carbon, steel, titanium, hard plastic, acrylic, wood, etc. The walking stick 10 can be a predetermined height or length or it can be of an adjustable height. As two nonlimiting examples, to provide for an adjustable height, the walking stick 10 can telescope or fold up to a smaller, more transportable length.

The gun rest 20 can have the design and material of many gun rests known in the art long as it provides a rest near the top end 12 of the hunting stick 1 to support a gun or archery device for hunting (FIG. 1). In one embodiment of the present invention, the gun rest 20 is movable along the length of the walking stick 10 so that the user can customize the height of the gun rest 20. Additionally, in one embodiment of the present invention, the gun rest 20 deploys quickly and easily from a stored position to an in-use position (for deployable versions). FIG. 1 illustrates a deployed gun rest 20. In alternative embodiments, the gun rest 20 can be stationary in a predetermined location along the walking stick 10. One mechanism to enable the gun rest 20 to move along the walking stick 10 is to combine it with a pressure lever 22 to secure and to move the rest 20 (FIG. 1).

In various embodiments of the present invention, a hunting blind 30 is located along the length of the walking stick 10, usually attached to the walking stick 10 at a point lower than the gun rest 20 (shown in FIGS. 1, 2A, and 2B). The hunting blind 30 can have a wide variety of designs and features of traditional hunting blinds and any workable options and combinations are included within the scope of the present invention. In one embodiment of the hunting blind 30 has a fan-like shape and spreading mechanism that enables the hunting blind 30 to fold up and remain secured and out of the way when not in use (such as when the hunting stick 1 is being used as a walking stick 10) (see FIGS. 1 and 2B). However, the hunting blind 30 of this embodiment of the invention quickly and easily deploys to provide cover to the user by fanning open around a pivot point 50 shown in FIG. 1. Various embodiments of a fan-shaped hunting blind 30 spread on ribs 44 that can be similar in structure to the ribs of collapsible fans or umbrellas known in the art.

In various embodiments, the hunting blind 30 can be permanently attached to the walking stick 10 or it can be detachable (as shown in FIGS. 2A and 2B). It will be obvious to one skilled in the art that there are a variety of ways to attach the hunting blind 30 to the walking stick 10, including but not limited to the use of sliding latch mechanism or the hooks attachments 42 illustrated in FIG. 2B.

The hunting blind 30 can be made from a wide variety of materials that will stand up to use and inclement weather, including but limited to cotton, waxed cotton, rubberized cotton, nylon, polyester, any water-resistant material, vinyl, plastic, silk, acetate, rayon, and Gore-Tex®, In one embodiment, the hunting blind 30 is made of a material that is water-repellent or resistant, wind resistant, durable, and folds up easily. The hunting blind 30 can be any dimensions that fit along the length of the walking stick 10 and enable easy opening/deployment and closing/storage of the hunting blind 30. The hunting blind 30 can have a variety of designs including solid colors and patterns, such as camouflage. For removable embodiments, the hunting blind 30 can be changed by the user to match the environment in which it will be used at any given time.

The hunting blind 30 embodiment, as shown in FIGS. 1 and 2B, is a semi-circular fan shape. The hunting blind 30 can be made in a variety of shapes and sizes so that the user can choose the amount of concealment that they desire versus the bulkiness of the overall hunting stick 1. The various hunting blinds 30 of the preset invention can expand to provide any degree of coverage from a portion of a circle to a full circular blind. Additionally, hunting blinds 30 of various embodiments of the present invention deploy to non-circular shapes. However, in one embodiment of the present invention, the closed hunting blind 30 has minimal bulk and is designed to collapse and secure tightly to the walking stick 10 so as to avoid interfering with the use of the hunting stick 1 as a walking stick.

In alternative embodiments of the presenting invention, the hunting stick 1 is designed with a flexible sleeve 40 that slides up or down over the hunting blind 30 to keep the hunting blind 30 closed and out of the way when not in use, similar to a sleeve that is used to store an umbrella. The sleeve 40 can be permanently attached to the walking stick 10 near the hunting blind 30 or it can be a separate piece of material or plastic that slides over the walking stick 10 and closed hunting blind 30 when needed. The incorporation of a flexible sleeve 40 also provided protection to the hunting blind 30 when it is not in use.

While the disclosure has been described in detail and referring to specific embodiments thereof, it will be apparent to one skilled in the art that various changes and modifications can be made without departing from the spirit and scope of the embodiments. Thus, it is intended that the present disclosure covers the modifications and variations of this disclosure provided they come within the scope of the appended claims and their equivalents.

1. A hunting stick comprising:
a walking stick having a top end and a bottom end;
a gun rest attached at or near the top end of the walking stick; and
a hunting blind secured to the walking stick between the top end and the bottom end.

2. The hunting stick of claim 1, further comprising at least one stability foot attached near the bottom end of the walking stick to provide additional support when the hunting stick is used as a gun rest.

3. The hunting stick of claim 1, wherein the walking stick is configured to have an adjustable length.

4. The hunting stick of claim 1, wherein the gun rest is moveable along the walking stick.

5. The hunting stick of claim 1, wherein the gun rest transitions from a stored configuration to a deployed configuration.

6. The hunting stick of claim 1, wherein the hunting blind is configured to transition between open and closed configurations.

7. The hunting stick of claim 6, wherein the hunting blind has a fan-like design that opens to provide semi-circular concealment and closes close to the walking stick.

8. The hunting stick of claim 1, wherein the hunting blind is removable from the hunting stick.

9. The hunting stick of claim 1, wherein the hunting blind attaches to the walking stick in at least two locations along the walking stick.

10. The hunting stick of claim 1, further comprising a flexible sleeve that slides over the closed hunting blind.

11. The hunting stick of claim 1, further comprising a foot peg located near the bottom end of the walking stick to facilitate inserting the bottom end of the walking stick into a ground.

12. The hunting stick of claim 1, wherein the walking stick is made from a material selected from the group consisting of aluminum, carbon, steel, titanium, hard plastic, acrylic, and wood.

13. A hunting stick comprising:
a walking stick having a top end and a bottom end; and
a fan-like hunting blind secured to the walking stick between the top end and the bottom end, wherein the fan-like hunting blinds spreads open for concealment and collapses into a closed position near the walking stick.

14. The hunting stick of claim 13, further comprising at least one stability foot attached near the bottom end of the walking stick to provide additional support when the hunting stick is used as a gun rest.

15. The hunting stick of claim 13, wherein the walking stick is configured to have an adjustable length.

16. The hunting stick of claim 13, wherein the hunting blind is removable from the hunting stick.

17. The hunting stick of claim 13, further comprising a flexible sleeve that slides over the closed hunting blind.

18. The hunting stick of claim 13, further comprising a foot peg located near the bottom end of the walking stick to facilitate inserting the bottom end of the walking stick into a ground.

19. The hunting stick of claim 13, wherein the hunting blind attaches to the walking stick in at least two locations along the walking stick.

20. The hunting stick of claim 13, wherein the walking stick is made from a material selected from the group consisting of aluminum, carbon, steel, titanium, hard plastic, acrylic, and wood.
